(19) United States
(12) Patent Application Publication
(10) Pub. No.: US 2024/0210537 A1
(43) Pub. Date: Jun. 27, 2024

(54) FREQUENCY-MODULATED CONTINUOUS-WAVE LIDAR WITH IMPROVED PROCESSING

(71) Applicant: COMMISSARIAT A L’ENERGIE ATOMIQUE ET AUX ENERGIES ALTERNATIVES, PARIS (FR)

(72) Inventors: Anis DAAMI, GRENOBLE (FR); Laurent FREY, GRENOBLE (FR); Josep SEGURA PUCHADES, GRENOBLE (FR)

(21) Appl. No.: 18/391,336

(22) Filed: Dec. 20, 2023

(30) Foreign Application Priority Data
Dec. 22, 2022 (FR) 2214276

(51) Int. Cl. G01S 7/4912; G01S 17/34; G01S 17/89

(52) U.S. Cl. CPC G01S 7/4917; G01S 17/34; G01S 17/89

(57) ABSTRACT

A continuous-wave lidar system includes a laser source configured to generate laser radiation (L) with a laser optical frequency f_{opt-I} varying linearly over a plurality of N successive frequency ranges indexed i, a first optical device configured to spatially separate the laser radiation (L), a detecting device, a second optical device configured to simultaneously deliver, to the pixel, a recombined beam, a frequency shifter placed on the path of the reference beam and configured to shift the laser optical frequency by a shift frequency comprised in the interval [f_{Rmax}, f_{Rmin}], a processing unit, the continuous-wave lidar imaging system further being configured to determine distance information from a signal detected by the pixel.

### CROSS-REFERENCE TO RELATED APPLICATION

This application claims priority to foreign French patent application No. FR 2214276, filed on Dec. 22, 2022, the disclosure of which is incorporated by reference in its entirety.

### FIELD OF THE INVENTION

The present invention relates to the field of active imaging and in particular to 3-dimensional scene imaging (distance and optionally radial velocity of objects). More particularly, the invention relates to frequency-modulated continuous-wave lidars for determining distance and, where appropriate, velocity information on the points of a scene to be observed.

### BACKGROUND

Measurement of a distance involves using a light source to illuminate the scene and a detector (more generally an image sensor) able to encode distance values (and/or velocity values) in order to obtain three-dimensional information on the entire observed scene. More exactly, to every point (x,y) of the scene, a depth value (z) and optionally a velocity value (v_{Z}) are assigned, so as to obtain a depth map z=f(x,y) and optionally a map of radial velocities v_{Z}=g(x, y).

A number of active imaging techniques are described in the literature. Mention may be made of structured-light and direct and indirect time-of-flight techniques. Here the techniques of interest are those that use a coherent light source (laser) and that divert a portion of the beam (local-oscillator beam) in order to use it as an amplifier of the signal backscattered by the scene once the latter has been illuminated (point by point or all at once, see below) by the rest of the undiverted beam.

The principle of continuous-wave lidar is well known in the prior art and is illustrated in FIG. 1. A continuous-wave lidar 1 comprises a coherent source, typically a laser Las, that emits a coherent frequency-modulated light wave L (in the IR, visible or near-UV domain) and a detecting device Det0 comprising at least one pixel P comprising a photodetector component PD. An emitting device illuminates a volume of space, and a receiving device collects a fraction of the light wave backscattered by a scene or target to be observed. On reception, the backscattered light wave and a portion of the emitted wave that was not transmitted to the scene, called the “local oscillator”, are mixed. The interference of these two waves is detected by the photodetector, and the electrical signal output by the detector contains an oscillating term proportional to the product of the power of the local oscillator multiplied by the power of the signal backscattered by the scene. This signal is digitized and distance and/or velocity information is extracted therefrom. The Doppler frequency shift of the backscattered wave is dependent on the radial velocity of the point that backscattered the wave:

The lidar 1 thus comprises a first optical device DO1 configured to spatially separate the laser radiation L into a reference beam Lref (local oscillator) and an object beam Lo that is directed towards a scene to be observed Sc. The lidar 1 also comprises a second optical device DO2 configured to simultaneously deliver, to the pixel P, a recombined beam Lrecomb corresponding to a superposition of the reference beam Lref and of a beam reflected by the scene Lo,r when it is illuminated by the object beam. The continuous-wave lidar imaging system is further configured to determine distance information from a signal Spix detected by the pixel P.

In FIG. 1 a single pixel has been shown, but the detector Det0 may in practice comprise a high number of pixels, arranged in a linear or matrix array.

Frequency-modulated continuous-wave (FMCW) lidars allowing a depth map to be determined are known. FIG. 2 schematically illustrates the operation of one known prior-art FMCW lidar 1.

The laser source LAS is configured to emit laser radiation L with an optical frequency f_{opt-LO} that varies linearly over at least one frequency range of width B for a duration T, as illustrated in FIG. 2. B is commonly referred to as the chirp. The backscattered wave, which has travelled twice the distance z from the lidar 2 to the scene, has a frequency f_{opt-sc}.

The two channels that interfere (Lref of frequency f_{opt-LO} and Lo,r of frequency f_{opt-sc}) on the photodetector produce beats the frequency of which is proportional to the delay Δt between the two channels, and therefore to the distance z. These beats are replicated in the detected electrical signal i_{PD}.

More precisely, for a linear ramp, the frequency of the oscillations is:

$${f}_{R} = \frac{2 B z}{c T} \qquad ( 1 )$$

with B the optical frequency excursion or chirp during the duration T of the ramp, and c the speed of light.

The distance z can be deduced from the number k (k≈Tf_{R}) of periods measured during the duration T (so-called counting method):

$$z \approx \frac{kc}{2 B} .$$

The distance resolution of the lidar is

$$δ z \approx \frac{c}{2 B} . \qquad ( 1 a )$$

It is also possible to measure f_{R} through spectral analysis via Fourier transform of the beat signal (so-called FFT method).

To form a complete image of the scene, a first known type of FMCW lidar sequentially illuminates the scene using a scanner and the recombined beam is detected by a single photodetector. In practice, it is difficult to acquire distance images of high resolution (for example VGA or XGA) at video rate (typically 50 Hz) because the time available for the distance measurement at each point is very short.

Thus, a second known type of FMCW lidar, such as described in the document WO2021144357 and illustrated in FIG. 3, allows information about points of the scene to be acquired in parallel by a high number of pixels. The single photodetector is replaced by a matrix-array imager 41 in which each pixel Pij contains a photoreceptor PDij that detects information corresponding to the image of a point of the scene, the image being formed by suitable optics. The beam Lo directed towards the scene illuminates the entire target surface in one go without being scanned. The local-oscillator beam Lref is also suitable for illuminating the entire surface of the imager. Since distance is proportional to the beat frequency of the heterodyne signal, it is therefore necessary to measure this frequency for each pixel if it is desired to obtain distance information for the entire scene simultaneously. Typically, the measurement may be performed simultaneously for all pixels (global-shutter mode) or line by line (rolling-shutter mode).

The lidar 3 of the aforementioned document comprises the laser source LAS, which is modulated in the time domain by the aforementioned chirp B of duration T, and the coherence length of the laser radiation is at least two times greater than the maximum predetermined distance zmax between the scene to be observed Sc and the lidar 3.

The lidar 3 also comprises an optical device DS, called a splitter, corresponding to the aforementioned first optical device DO1.

The second optical device DO2 comprises an optical combiner DR configured to spatially superpose the reference beam Lref on the beam reflected by the scene Lo,r, so as to form the recombined beam. The second optical device DO2 also comprises an optical imaging system Im of optical axis AO (diaphragm Diaph) that forms an image of the scene by imaging the beam reflected by the scene Lo,r on the detector 41. Since the scene is typically at a distance much greater than the focal length of the optics Im, the detector 41 is placed substantially in the focal plane of the optics Im.

The optical devices DO1 and DO2 are configured so that each pixel Pij of the detector receives a portion of the image beam returned by the scene, which portion is designated Lo,r/pix, and a portion of the reference beam, which portion is designated Lref/pix, and so that these portions spatially superpose on each pixel. Preferably, these devices are configured, for example through addition of an additional optics SI (not shown), to convey the reference beam from the laser source to an intermediate image plane PI perpendicular to the optical axis AO of the imaging optical system Im, so as to produce a (virtual or real) reference source coherent with the reflected beam. The intermediate plane PI is located in proximity to the imaging optical system, so as to generate uniform-field fringes, which are obtained by interference between the portion Lo,r/pix of the reflected beam and the portion Lref/pix of the reference beam detected by each illuminated pixel Pij. For the sake of simplicity, the beam portion illuminating a pixel is considered equivalent to the beam portion detected by the photodetector of this pixel. This uniform-field condition implies that, on each pixel Pij, an axis of propagation of the portion Lo,r/pix of the reflected beam is collinear or substantially collinear with an axis of propagation of the portion Lref/pix of the reference beam. A virtual or real intermediate image PS of the reference beam is formed in the intermediate image plane PI, the plane PI being placed so as to generate uniform-field fringes, obtained by interference between the portions, on each illuminated pixel.

The continuous-wave lidar imaging system 3 further comprises at least one electronic processing circuit configured to compute, for each pixel Pij, a frequency F(i,j) of the beat of the portion of the image beam with the portion of the reference beam illuminating the pixel.

Lastly, the lidar 3 comprises a processing unit UT connected to the laser source and to the detector 41, and configured to determine a distance of points of the scene that are imaged on the pixels, from the computed beat frequency associated with each pixel and from the modulated optical frequency of the laser radiation. The processing circuit may be located in each pixel, in a row or a column, or in the processing unit UT.

Providing a local oscillator for each pixel makes it possible to simultaneously obtain an image of each point of the scene. Thus, the architecture of the lidar 3 incorporating a matrix-array detector is compatible with a high number of pixels (no scanning) allowing a high-resolution lidar image to be produced. The heterodyne mixing here takes place in each pixel.

In the lidar 3, B and T are constant. To detect a point at a distance z comprised between zmin and zmax, the frequency f_{R} must be measurable over the entire extent of the range Δf_{R} from f_{Rmin}, which is defined by zmin, to f_{Rmax}, which is defined by zmax. Δf_{R} is therefore the frequency range of the signal to be measured and:

$$Δ {f}_{R} = 2. B . ( z max - z min ) / c . T \qquad ( 2 )$$

When the distance range to be measured increases, Δf_{R} increases, this implying that the bandwidth of the one or more circuits used to amplify i_{PD} increases, this increasing noise and the power consumption of these circuits. This also increases the photonic noise of the DC component of i_{PD} and decreases signal-to-noise ratio. Specifically, as known, signal-to-noise ratio is inversely proportional to \sqrt{Δf_{R}}. A decrease in signal-to-noise ratio may lead to an erroneous count as a result of noise.

Furthermore, generally, a difficulty remains in respect of measurement of the frequency of the beat signal. Both in the case of the FFT method and in the case of the counting method, it is necessary to integrate complicated and fairly dense electronics into each pixel. As a result it is not possible to realize global-shutter imagers, given the number of MOS transistors that would have to be fitted into the area of a single pixel. Even in the case of a rolling-shutter imager where some of the electronics are placed at the column bottom, it is difficult to achieve a video rate with this kind of solution.

### SUMMARY OF THE INVENTION

One aim of the present invention is to overcome the aforementioned drawbacks by providing a continuous-wave lidar imaging system allowing the complexity of the detection electronics required to measure the frequency of the heterodyne signal to be decreased and signal-to-noise ratio to be improved.

One subject of the present invention is a continuous-wave lidar system comprising:
a laser source configured to generate laser radiation with a laser optical frequency f_{opt-I} varying linearly over a plurality of N successive frequency ranges indexed i, with N greater than or equal to 2, a frequency range having a width Bi and a duration Ti, a sum of all said frequency ranges corresponding to an overall duration, an absolute value of a ratio Bi/Ti being different for each frequency range,
a first optical device configured to spatially separate the laser radiation into a reference beam and an object beam that is directed towards a scene to be observed,
a detecting device comprising at least one pixel comprising a photodetector component,
a second optical device configured to simultaneously deliver, to said pixel, a recombined beam (Lrecomb) corresponding to a superposition of the reference beam and of a beam reflected by the scene when it is illuminated by the object beam,
a frequency shifter placed on the path of the reference beam and configured to shift the laser optical frequency by a shift frequency comprised in the interval [f_{Rmax}, f_{Rmin}], with f_{Rmax} and f_{Rmin} corresponding to a beat heterodyne frequency associated with a maximum measurement distance and to a minimum measurement distance in the absence of said frequency shifter, respectively,
a processing unit configured to drive the laser source and connected to the detecting device,
the continuous-wave lidar imaging system further being configured to determine distance information from a signal detected by said pixel, the distance information being determined from the values Bi₀ and Ti₀ of the laser optical frequency range applied at the time when a beat frequency of the detected signal is zero or minimized.

According to one embodiment, each frequency range indexed i corresponds to a range of distances from the sensor to the scene Δzi ranging from zₘᵢₙᵢ to zₘₐₓᵢ with zₘᵢₙᵢ<zₘₐₓᵢ, and the ratios Bi/Ki are determined so that for i ranging from 1 to N−1:

$${z}_{{max}_{i}} = {z}_{{min}_{i + 1}}$$

where:

$$Ki = \frac{{z}_{{max}_{i}}}{{z}_{{min}_{i}}}$$

According to one embodiment, the durations Ti are all identical.

According to one embodiment, the widths Bi satisfy the relationship:

Bᵢ=K·Bᵢ₊₁ K being a real number greater than 1.

According to one embodiment, the continuous-wave lidar system according to the invention further comprises a scanner configured to illuminate the scene with the object beam point by point or line by line.

According to another embodiment, the laser source and/or the first optical device are configured to illuminate the entire scene, the detector comprises a plurality of pixels arranged in a matrix array, and the second optical device is configured to superpose, on the photodetector of each pixel, the reference beam and the beam reflected by the scene in a substantially identical direction of propagation.

According to one embodiment, the frequency shifter comprises at least one acousto-optic modulator operating in the order −1.

According to one embodiment, a modulation in frequency range i is called sub-phase i, and each pixel comprises a read circuit coupled to the photodetector, the read circuit comprising:
an integrator (INTEG) that integrates, in each sub-phase, a reference signal (REF) detected by the pixel when the laser beam is not frequency modulated and the pixel signal detected during said sub-phase,
a comparator (COMP) that compares the integrated reference signal (REF′) and the integrated pixel signal (Spix′), and switches to the high state when the integrated pixel signal is different from the integrated reference signal, and
a logic circuit (CLOG) that delivers the address (Xadd, Yadd) of said pixel when the comparator is in the high state.

According to another aspect, the invention relates to a method for acquiring a distance from a continuous-wave lidar system to a scene, comprising steps of:
A generating laser radiation with a laser optical frequency f_{opt-I} varying linearly over a plurality of N successive frequency ranges indexed i, a frequency range having a width Bi and a duration Ti, a sum of all said frequency ranges corresponding to an overall duration, an absolute value of a ratio Bi/Ti being different for each frequency range,
B spatially separating the laser radiation into a reference beam and an object beam that is directed towards a scene to be observed,
C illuminating the scene with the object beam,
D shifting the laser optical frequency of the reference beam by a shift frequency comprised in the interval [f_{Rmax}, f_{Rmin}], with f_{Rmax} and f_{Rmin} corresponding to a beat heterodyne frequency associated with a maximum measurement distance and to a minimum measurement distance in the absence of said shift in the laser optical frequency of said reference beam, respectively,
E simultaneously delivering, to at least one pixel of a detecting device, a recombined beam corresponding to a superposition of the reference beam and of a beam reflected by the scene, detecting said recombined beam and generating a detected signal,
F determining, from the detected signal, a time when a beat frequency of the detected signal is zero or minimized,
G determining the values Bi₀ and Ti₀ of the range of the laser optical frequency applied at said time,
H determining distance information from said values Bi₀ and Ti₀.

According to one embodiment, a modulation in frequency range i is called sub-phase i, and, in step A, the optical frequency of the generated laser radiation is not modulated for a duration T0 prior to the durations Ti, and, in step E, a signal called the reference signal is detected during the duration T0, and step F comprises a comparing sub-step in which, for each sub-phase, the reference signal integrated during said sub-phase and the detected signal integrated during said sub-phase are compared.

The following description presents a number of examples of embodiment of the device of the invention: these examples do not limit the scope of the invention. These examples of embodiment contain not just features that are essential to the invention but also additional features associated with the embodiments in question.

### BRIEF DESCRIPTION OF THE DRAWINGS

The invention will be better understood and other features, aims and advantages thereof will become apparent from the following detailed description, which is given with reference to the appended drawings, which are given by way of non-limiting example and in which:

FIG. 1, which has already been mentioned, illustrates the principle of a known continuous-wave lidar.

FIG. 2, which has already been mentioned, illustrates the known principle of frequency-modulated lidar.

FIG. 3 illustrates a known variant of a frequency-modulated lidar in which the entire scene is illuminated simultaneously and the signal is detected on an imager comprising multiple pixels.

FIG. 4 illustrates a first example of frequency modulation for a so-called multi-chirp lidar.

FIG. 4a illustrates a second example of frequency modulation for a multi-chirp lidar.

FIG. 5 illustrates an intuitive way of avoiding measurement of the frequency of the heterodyne signal for a mono-chirp laser of parameters (B, T) that is not realizable.

FIG. 6 illustrates another way of flattening the heterodyne signal consisting in shifting the optical frequency of the reference beam by a frequency fd.

FIG. 7 illustrates the concept of shift of the frequency of the wave generated by the laser, applied to a mono-chirp lidar of parameters (B, T) and of frequency fd varying in the interval [f_{Rmin}; f_{Rmax}], so that the difference between the reference frequency and the shifted reference frequency covers a set of frequencies comprising the frequency f_{R} to be measured.

FIG. 8 illustrates one example of the frequency shift fd0 for a modulation of the laser source of a multi-chirp lidar such as illustrated in FIG. 4.

FIG. 9 illustrates a continuous-wave lidar system 10 according to the invention.

FIG. 10 illustrates a first variant of the continuous-wave system according to the invention further comprising a scanner configured to illuminate the scene with the object beam point by point.

FIG. 11 illustrates a second variant of the continuous-wave lidar system according to the invention that has an architecture such as illustrated in FIG. 3. The laser source and/or the first optical device D1 are configured to illuminate the entire scene, and the detector comprises a plurality of pixels arranged in a matrix array.

FIG. 12 illustrates the use of an acousto-optic modulator as a frequency shifter.

FIG. 13 illustrates an embodiment of the frequency modulation of the laser source incorporating a calibration phase.

FIG. 14 illustrates an embodiment of detection of the zero frequency at the pixel level.

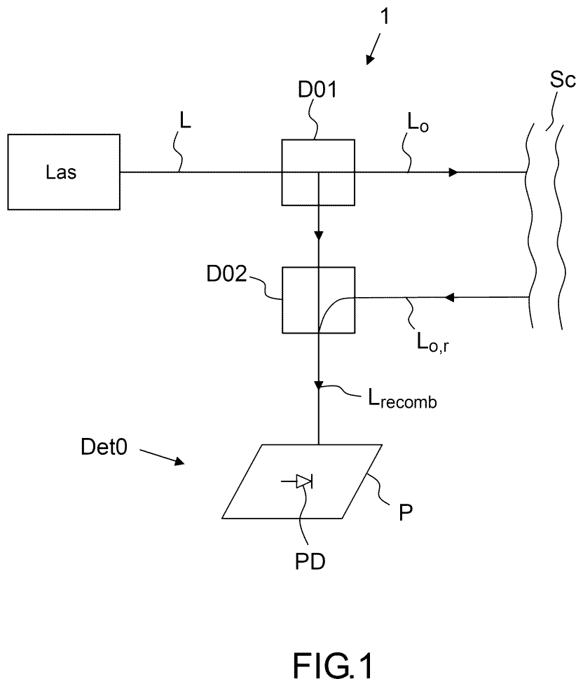

### DETAILED DESCRIPTION

Document FR2207829 (not published at the date of filing of the present application) proposes to improve signal-to-noise ratio while maintaining the same dynamic range zₘᵢₙ-zₘₐₓ, by decreasing bandwidth Δf_{R}.

To do this, the overall acquisition duration T is divided into N consecutive intervals of duration Ti, i ranging from 1 to N, N≥2. Each capture interval or sub-phase Ci corresponds to delivery of a beam having its optical frequency f continuously and linearly modulated over a frequency range of width Bi during the duration Ti of this sub-phase. Furthermore, provision is made for each sub-phase Ci to correspond to a ratio Bi/Ti different from the ratios Bi/Ti of the N−1 other sub-phases.

Each sub-phase Ci (Bi, Ti) then corresponds to a bandwidth Δf_{Ri} that is small with respect to Δf_{R} and makes it possible to detect distances z comprised in a range Δzi ranging from zₘᵢₙᵢ to zₘₐₓᵢ with zₘᵢₙᵢ<zₘₐₓᵢ. The bandwidth of each of the sub-phases Ci extends from a minimum frequency f_{Rmini} to a frequency f_{Rmaxi}:

$$Δ {f}_{Ri} = {f}_{Rmaxi} - {f}_{Rmini} \\ with : \\ {f}_{{Rmax}_{i}} = \frac{2 {z}_{{max}_{i}} {B}_{i}}{{cT}_{i}} \qquad ( 3 )$$

$$and$$

$${f}_{{Rmin}_{i}} = \frac{2 {z}_{{min}_{i}} {B}_{i}}{{cT}_{i}} \qquad ( 4 )$$

and therefore:

$$Δ {f}_{{R}_{i}} = \frac{2 Δ {z}_{i} . {B}_{i}}{{cT}_{i}} \\ with Δ zi = {z}_{maxi} - {z}_{mini} . \qquad ( 5 )$$

To a given sub-phase Ci and to a given pixel there corresponds a measured beat frequency f_{Ri} of the heterodyne signal comprised between f_{Rmini} and f_{Rmaxi} if the point associated with the pixel is at a distance z from the pixel comprised between zₘᵢₙᵢ and zₘₐₓᵢ, and the distance z may be calculated with the formula:

$$z = \frac{c . Ti . {f}_{Ri}}{2. Bi}$$

A lidar having such a frequency modulation is called a multi-chirp lidar.

The ratios Bi/Ti are determined so that for i ranging from 1 to N−1 zₘᵢₙᵢ₊₁ is substantially equal to zₘₐₓᵢ without being strictly greater than zₘₐₓᵢ.

According to one preferred embodiment, in order for the various measurement phases to retain distance continuity (thus avoiding overlapping ranges) preferably the following is true:

$${z}_{{max}_{i}} = {z}_{{min}_{i + 1}} \qquad ( 6 )$$

For each sub-phase Ci (or frequency range), the coefficient Ki is defined such that:

$${f}_{Rmaxi} = Ki . {f}_{Rmini} \qquad ( 7 )$$

Thus, according to formulae (3) and (4):

$$Ki = \frac{{z}_{{max}_{i}}}{{z}_{{min}_{i}}}$$

According to one embodiment, Ki is identical for all i with Ki=K, K being a real number strictly greater than 1. However, in other examples, the Ki values of at least two sub-phases are different.

With K constant this implies that:

$${f}_{Rmaxi} = K . {f}_{Rmini}$$

and for all i

$${B}_{i} = K . {B}_{i + 1} \qquad ( 9 )$$

$$and$$

$$\frac{{z}_{{min}_{i + 1}}}{{z}_{{min}_{i}}} = \frac{{z}_{{max}_{i + 1}}}{{z}_{{max}_{i}}} = K \qquad ( 10 )$$

$$or$$

$${z}_{{max}_{i}} = K . {z}_{{min}_{i}} \qquad ( 11 )$$

According to one embodiment, the durations Ti are all identical, and therefore:

$$Ti = T / N .$$

According to one embodiment, f_{Rmini} is chosen to have the same value in each sub-phase Ci, this value being denoted f_{Rmin}, and f_{Rmaxi} is chosen to have the same value in each sub-phase Ci, this value being denoted f_{Rmax}. This minimizes the bandwidth of the pixel, which is equal to (f_{Rmax}−f_{Rmin}). The distance z is determined by recording the time at which the pixel measures a frequency comprised in the interval [f_{Rmin}, f_{Rmax}]. This time is located in only one of the sub-phases. Since the Bi and Ti of this sub-phase are known, z may be determined.

For constant K this implies that the sub-phases all have the same frequency f_{Rmin} and the same frequency f_{Rmax} and therefore that they all have the same bandwidth Δf_{R}.

In this case, starting with (11) and choosing zₘᵢₙ₌zₘᵢₙ_{₁} and zₘₐₓ=zₘₐₓ_{_{N}} the following is obtained:

$$\frac{{z}_{max}}{{z}_{min}} = {K}^{N} \qquad ( 12 )$$

With this set of equations, knowing zmin and zmax and the value of K, it is possible to determine N with (12) (N for example being the rounded integer above the value obtained by taking the logarithm to base K of (zmax/zmin). Then, since the value of T is known, Ti=T/N may be deduced therefrom.

Bi, zmini and zmaxi are determined with the equations:

$${B}_{i} = \frac{{B}_{1}}{{K}^{i - 1}} \qquad ( 13 )$$

$${z}_{m i {n}_{i}} = {K}^{i - 1} \cdot {z}_{m i n} \qquad ( 14 )$$

$${z}_{m {ax}_{i}} = \frac{{z}_{m ax}}{{K}^{N - i}} \qquad ( 15 )$$

The frequency f_{Rmin} (which is identical in all the sub-phases) is also chosen and the following may be deduced:

$$B 1 = \frac{{f}_{Rmin} c \cdot T}{2 \cdot N \cdot {z}_{m i n}}$$

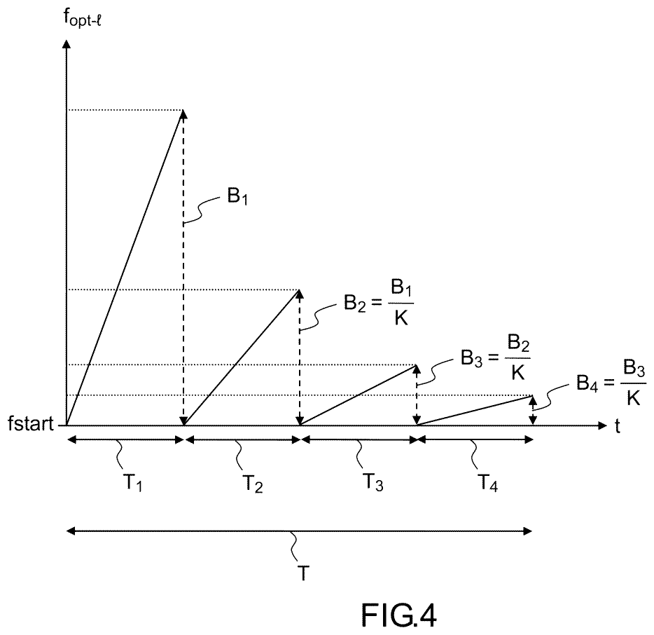

FIG. 4 illustrates a first example of frequency modulation with K constant, the Ti are all identical and N=4. In this example, the frequency of the laser beam is modulated from the same frequency fstart, this meaning that at the end of each sub-phase the frequency must be instantaneously returned to the frequency fstart. The laser source and its control circuit CCL must meet this need.

FIG. 4a illustrates a second example in which there is no instantaneous frequency return, with as before K constant, the Ti are all identical and N=4. In this example, provision is made for the last frequency of sub-phase Ci, fendᵢ, to be equal to the first frequency of the following sub-phase, fstartᵢ₊₁. In addition in this example the sign of Bi, or in other words the direction of change of the frequency chirp Bi, changes in each new sub-phase.

A particular numerical example will be described that illustrates determination of the various parameters.

In all the sub-phases, T=200 μs; zmin=0.3 m (zmin=zmini) and zmax=10 m (zmax=zmaxN); K=2; and f_{Rmin}=75 kHz; and the Ti are all identical.

The dynamic range zmax/zmin=33.33.

It is deduced therefrom that:
N=5 that is Ti=40 μs.
f_{Rmax}=150 kHz and Δ_{fR}=75 kHz in each sub-phase.
B1=1.5×10⁹ Hz and sub-phase C1 allows distances z comprised between zₘᵢₙ₁=0.3 m and zₘₐₓ₁=0.6 m to be detected.
B2=750×10⁶ Hz and sub-phase C2 allows distances z comprised between zₘᵢₙ₂=0.6 m and zₘₐₓ₂=1.2 m to be detected.
B3=375×10⁶ Hz and sub-phase C3 allows distances z comprised between zₘᵢₙ₃=1.2 m and zₘₐₓ₃=2.4 m to be detected.
B4=187.5×10⁶ Hz and sub-phase C4 allows distances z comprised between zₘᵢₙ₄=2.4 m and zₘₐₓ₄=4.8 m to be detected.
B5=93.75×10⁶ Hz and sub-phase C5 allows distances z comprised between zₘᵢₙ₅=4.8 m and zₘₐₓ₅=9.6 m to be detected.

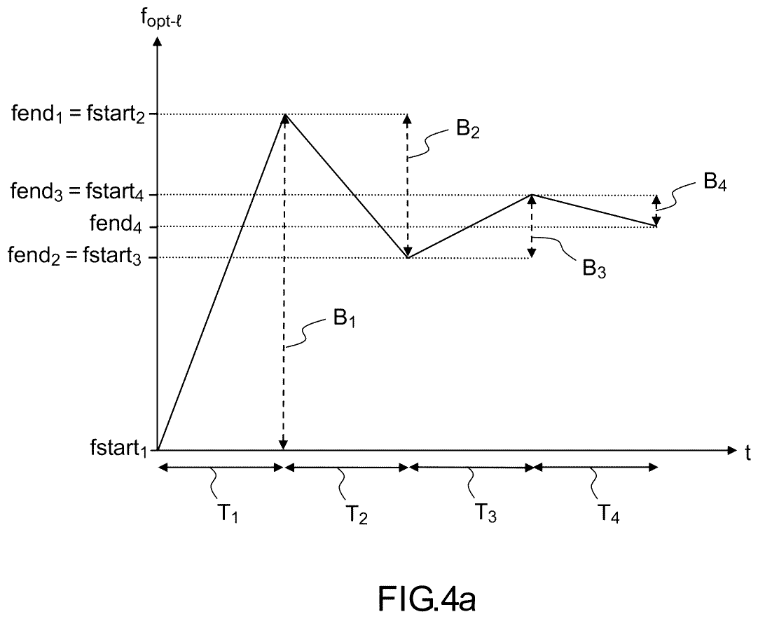

For a mono-chirp laser of parameters (B, T) an intuitive way of avoiding the need to measure the frequency of the heterodyne signal would be to achieve the same time delay Δt_{LO} on the 2 arms, namely the LO arm (reference signal Lref) and the scene arm, as illustrated in FIG. 5. This would result in a beat signal of zero frequency. The distance would then be encoded in the delay added to the LO arm as Δt_{LO}=2z/c. It should be obvious that this way of proceeding is almost impossible to achieve in practice.

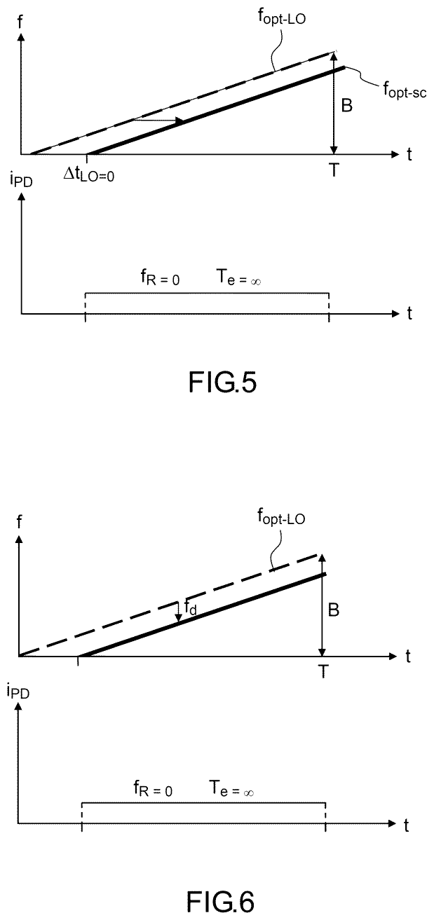

A second way of flattening the heterodyne signal amounts to acting on the optical frequency of the beam Lref. For a mono-chirp lidar of parameters (B, T) this concept, which is illustrated in FIG. 6, consists in shifting the optical frequency of the beam Lref by a frequency fd in such a way as to obtain f_{opt-LOd}=f_{opt-LO}-fd=f_{opt-sc} with f_{opt-LO} the frequency emitted by the laser, which corresponds to the frequency of Lref such as described in the prior art. In this way, the signal Lref of shifted frequency f_{opt-LOd} interfering with the signal from the scene of frequency f_{opt-sc} produces a constant heterodyne signal with a zero beat frequency, which is detected on the imager with simpler electronics.

Thus, FIGS. 5 and 6 explain the difference between adding a time delay and the shift in optical frequency of Lref. Both solutions produce a heterodyne signal with a zero beat frequency.

To clarify the notations, below:
f_{opt-I} denotes the optical frequency emitted by the laser (which corresponds to the “conventional” reference/local-oscillator frequency f_{opt-LO}),
f_{R} denotes a conventional beat frequency such as described above,
fd denotes the shift frequency,
f_{opt-LOd} denotes the shifted frequency of the local-oscillator beam Lref according to the invention, which is also called the shifted reference frequency, and
fs denotes the frequency of the beat signal resulting from the interference of Lref of shifted frequency f_{opt-LOd} with the signal Lo,r returned by the scene of frequency f_{opt-sc}, which is also called signal beat frequency:

$$fs = \vert {f}_{opt - LOd} - {f}_{opt - sc} \vert$$

The signal beat frequency fs is determined from the signal Spix detected by the photodetector.

The concept of the shift applied to a mono-chirp lidar of parameters (B, T) is to shift (decrease) the frequency f_{opt-I} of the wave generated by the laser (“conventional” reference frequency) by a frequency fd varying in the interval [f_{Rmin}; f_{Rmax}], so that the difference between the reference frequency and the shifted reference frequency covers a set of frequencies comprising the frequency f_{R} to be measured. The frequency f_{opt-LOd} is thus comprised between [f_{opt-I}-f_{Rmax}; f_{opt-I}−f_{Rmin}]. With a shift frequency fd varying in the interval [f_{Rmin}; f_{Rmax}] the signal beat frequency fs is zero or minimized at a given “time” (in fact a time range so as to be able to measure a frequency).

It will be recalled that, in the mono-chirp case, the minimum and maximum beat frequencies f_{Rmin} and f_{Rmax} are given by:

$${f}_{Rmin ( m o n o )} = \frac{2 B {z}_{m i n}}{c T}$$

$${f}_{R m ax ( m o n o )} = \frac{2 B {z}_{m a x}}{c T}$$

The information on distance z is then encoded in the particular fd value fda corresponding to this “time”, such that:

$$\vert fda \vert = \frac{2 B z}{c T} .$$

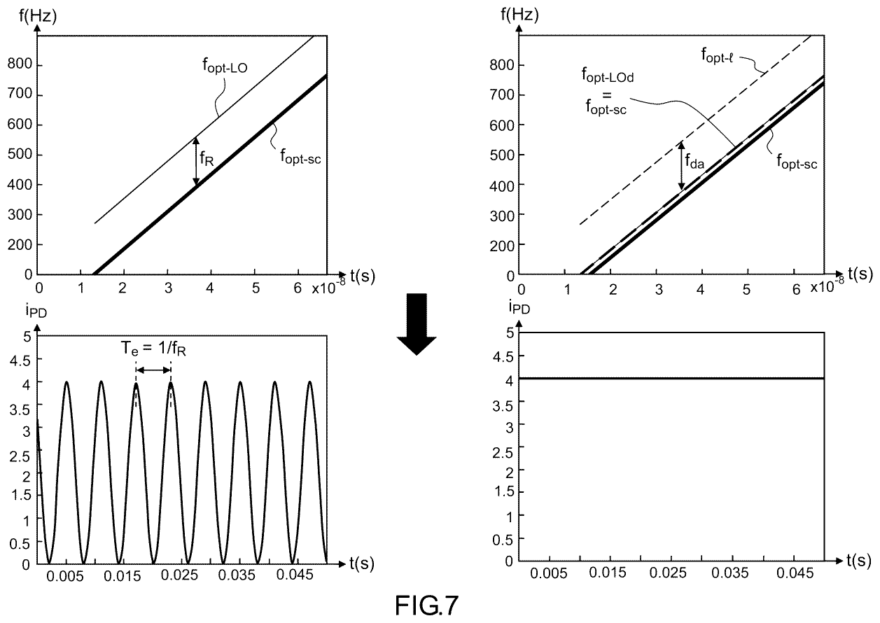

This principle is summarized in FIG. 7 for an example in which B=10 GHz; T=800 ms; and z=2 m. With formula (1) it is calculated that f_{R}=166.67 Hz.

On the left is illustrated the conventional operation of an FMCW lidar, and on the right the operation of a lidar according to the invention in which the frequency of Lref has been decreased until its value coincides with the frequency f_{opt-sc} returned by the scene.

The lidar according to the invention is a multi-chirp lidar to which the aforementioned shift concept is applied, in order to improve its performance. In this case, it is sought to decrease the beat frequency fs to zero in one or more sub-phases, depending on the distances of the objects of the scene.

It is desired to measure the distance z with a distance resolution δz.

The coefficient K is then chosen so that the range of distances to be measured corresponds to the theoretical resolution of the FMCW system which is zₘₐₓ_{ᵢ}−zₘᵢₙ_{ᵢ}=Δzᵢ=c/2Bᵢ in each measurement phase (see formula 1a).

Δzᵢ changes depending on the phase, and therefore so does resolution. This is not a problem; in practice distance resolution will degrade with distance in absolute value, but this is generally acceptable. For example: resolution of 1 mm at 1 m, and of 1 cm at 10 m.

By way of example, the best resolution:

Δz=c/(2·B1) may be employed in every phase.

This therefore implies that zₘₐₓᵢ−zₘᵢₙᵢ≤Δz whatever the value of i.

Since zmaxᵢ=K·zminᵢ is known, it is possible to write:

zₘᵢₙᵢ·(K−1)≤Δz whatever the value of i.

Therefore K≤Δz/zₘᵢₙᵢ+1 whatever the value of i.

The worst case is for the largest zminᵢ and therefore i=N:

$$K \leq Δ z / z {min}_{N} + 1 .$$

Since it is known that zmin_{N}=K^{N-1}·zmin it is implied that:

$$K \leq Δ z / {K}^{N - 1} \cdot z min ) + 1.$$

An interesting case is when zmin=Δz.

This makes it possible to choose K such that K^{N}≤K^{N-1}+1.

This formula is always true for K≥1.

More generally, if a resolution Δz is chosen, it is necessary for K≤Δz/z_{minN}+1 for all the following phases to have this resolution. In other words, K must tend towards 1 if better resolutions are desired.

In the case of the invention where a frequency of the optical source is modulated by a multi-chirp, a single shift frequency fd0, chosen in the interval [f_{Rmin}; f_{Rmax}], will allow the beat frequency fs to be decreased to zero in a sub-phase Ci associated with the distance interval [zₘᵢₙᵢ; zₘₐₓᵢ] comprised in the distance excursion [zmin; zmax] of the desired lidar. In other words, in each sub-phase Ci, fs will decrease to zero for the distances comprised between zₘᵢₙᵢ and zₘₐₓᵢ of said sub-phase.

The frequencies f_{Rmin} and f_{Rmax} (corresponding to zmin and zmax) are the frequencies of the minimum and maximum heterodyne beat signal in the multi-chirp case in the absence of a frequency shifter, respectively.

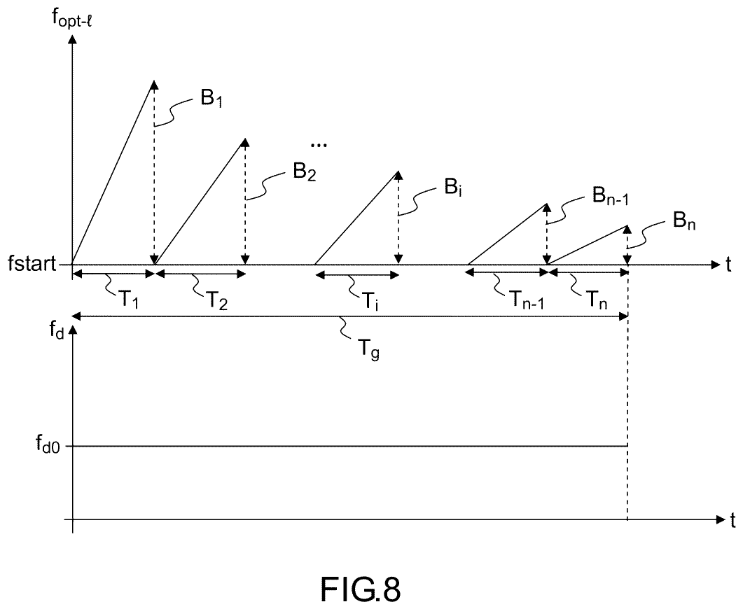

One example of the applied frequency shift fd0 is illustrated in FIG. 8 for a modulation of the laser source such as illustrated in FIG. 4.

The time at which the beat frequency becomes zero or minimized (this time is in fact a time range so as to be able to measure a frequency) is then identified, during detection. To identify this time, according to one embodiment, it is detected that the DC level of the measured signal is different from the DC level of the signal without modulation (ambient signal), because it is added to the latter (see below).

Once this time has been identified, the pair of parameters (Bi₀,Ti₀) corresponding to the instantaneous frequency of the applied laser source, and which contains the distance information z to be measured, is determined:

$$fd 0 = {f}_{opt - l} - f {0}_{opt - LOd} = \frac{2 \cdot {Bi}_{0} \cdot z}{c \cdot {Ti}_{0}}$$

$$i . e .$$

$$z = \frac{c \cdot {Ti}_{0} \cdot fd 0}{2 \cdot {Bi}_{0}} \qquad ( 19 )$$

The shift frequency fd0 is chosen between f_{Rmax} and f_{Rmin}.

Thus, with a multi-chirp lidar according to the invention, a heterodyne frequency is no longer measured but rather a time is determined at which the frequency of the detected signal is zero or minimal (or at which the detected signal is different from the ambient DC signal). This time is determined by a local read circuit CL located in the simplified pixel. The benefit of the increase in signal-to-noise ratio inherent to multi-chirp lidar is also reaped.

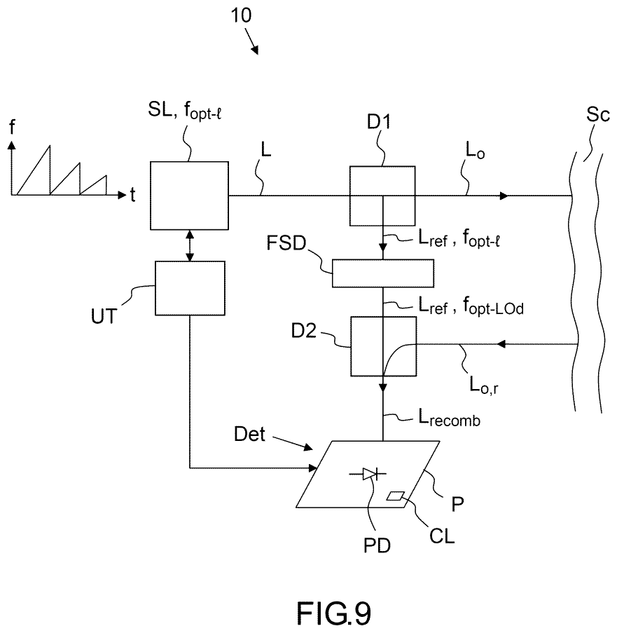

FIG. 9 illustrates a continuous-wave lidar system 10 according to the invention. It comprises a laser source SL configured to generate laser radiation L with a laser optical frequency f_{opt-I} varying linearly over a plurality of N successive frequency ranges indexed i, with N greater than or equal to 2. Each frequency range has a width Bi and a duration Ti, a sum of all said frequency ranges corresponds to an overall duration T, and an absolute value of a ratio Bi/Ti is different for each frequency range, such as described above.

The lidar 10 also comprises a first optical device D1 configured to spatially separate the laser radiation L into a reference beam Lref and an object beam Lo that is directed towards the scene to be observed Sc, and a detecting device Det comprising at least one pixel P comprising a photodetector component PD. The lidar 10 also comprises a second optical device D2 configured to simultaneously deliver, to said pixel, a recombined beam Lrecomb corresponding to a superposition of the reference beam Lref and of a beam reflected by the scene Lo,r when it is illuminated by the object beam.

The lidar 10 also comprises a frequency shifter FSD placed on the path of the reference beam and configured to shift the laser optical frequency by a shift frequency fd0 comprised in the interval [f_{Rmin}, f_{Rmax}].

The frequencies f_{Rmax} and f_{Rmin} respectively correspond to the heterodyne beat frequency associated with a maximum measurement distance zmax and with a minimum measurement distance zmin in the absence of the shifter FSD. The frequency of the reference beam output by the modulating device is called the shifted reference frequency f_{opt-Lod}.

The lidar 10 also comprises a processing unit UT that is configured to drive the laser source (via its control circuit CCL) and that is connected to the detecting device Det.

The continuous-wave lidar system 10 according to the invention is further configured to determine distance information from a signal Spix detected by the pixel P. The information of distance z associated with P (distance from the lidar 10 to the point of the scene the reflected signal of which is detected by P) is determined from the values Bi₀ and Ti₀ of the laser optical frequency range applied at the time when the beat frequency fs of the detected signal is zero or minimized, as explained above.

The processing unit UT, which is connected to the control circuit of the laser source CCL, allows the frequency range of parameters (Bi₀, Ti₀) to be identified, once the time at which fs decreases to zero has been determined by the read circuit CL.

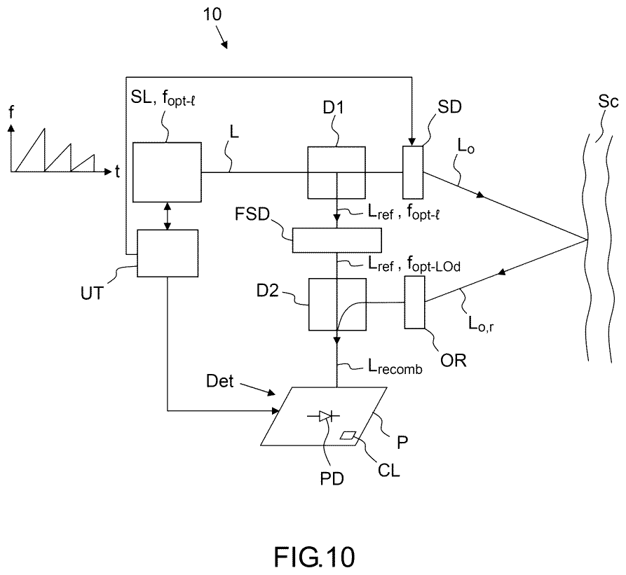

According to a first variant illustrated in FIG. 10, the continuous-wave system according to the invention further comprises a scanner SD configured to illuminate the scene with the object beam point by point (first embodiment). According to a second embodiment, the device SD illuminates the scene line by line.

In the first embodiment, each point of the scene must be illuminated for a duration at least equal to T (to make identification of the zero/minimum fs possible) and the detector comprises a single pixel.

In the second embodiment, a line of the scene must be illuminated for a duration at least equal to T, and the detector comprises a strip of pixels.

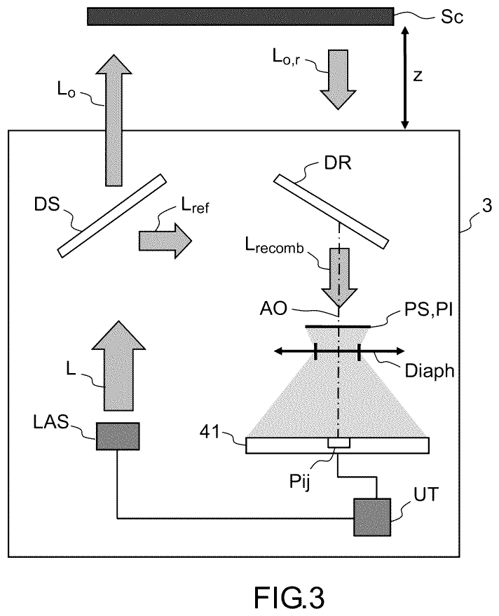

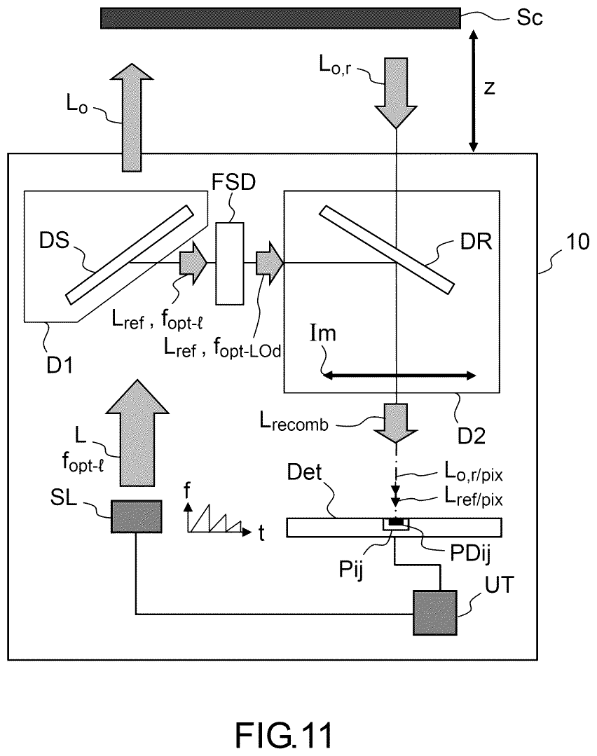

According to a second variant illustrated in FIG. 11, the continuous-wave lidar system 10 according to the invention has an architecture such as described in document WO2021144357 and recalled in FIG. 3. The laser source and/or the first optical device D1 are configured to illuminate the entire scene, and the detector comprises a plurality of pixels Pij arranged in a matrix array. The second optical device D2 is configured to superpose, on the photodetector PDij of each pixel, the reference beam Lref/pix and the beam reflected by the scene Lo,r/pix in a substantially identical direction of propagation. To this end, the device D2 typically comprises an optical combiner DR such as described above and an optical imaging system Im such as described above.

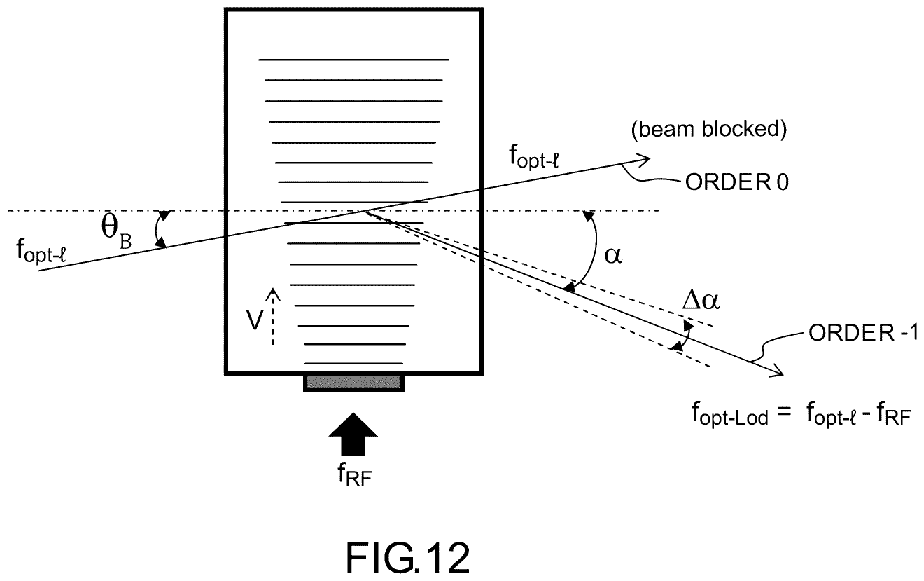

According to one embodiment, the frequency shifter FSD placed on the path of the reference beam (local oscillator) is an acousto-optical modulator AOM as illustrated in FIG. 12. An acousto-optic modulator is based on the principle of the photo-elastic effect. An acoustic wave of frequency f_{RF} propagates through a material, this slightly perturbing the optical parameters of this material and creating a grating of pitch Λ, the wavelength of the acoustic wave. The incident optical beam is deflected by the grating (diffraction) proportionally to the frequency of the acoustic wave propagating through the material. In addition, the optical frequency of the deflected beam is shifted by the value of the frequency of the acoustic wave f_{RF}.

The regime most often used in acousto-optic modulators is the Bragg regime where only the first order (±1) of diffraction exists. This regime is obtained when the angular extension of the acoustic wave is very small (plane acoustic wave). To obtain maximum diffraction, the angle of incidence of the optical wave must satisfy Bragg's law:

$$sin {θ}_{B} \approx {θ}_{B} = \frac{{λ}_{opt}}{2 Λ}$$

where λₒₚₜ is the wavelength of the optical beam, Λ is the wavelength of the acoustic wave and θ_{B} is the Bragg angle of incidence of the optical beam.

In addition, in an isotropic medium, the diffraction angle of the first order (+1 or −1) α=2θ_{B}.

As known:

$$α = \frac{{λ}_{opt} \cdot {f}_{RF}}{V}$$

where V is the speed of the acoustic wave in the material.

It is thus possible to shift the frequency fopt-I of the wave by a value equal to f_{RF}. When the optical wave is diffracted in the order +1 the frequency f_{RF} is added to the optical frequency and when the optical wave is diffracted in the order −1 the frequency f_{RF} is subtracted from the optical frequency. As it is desired here to decrease the laser reference frequency fopt-I, the AOM is used in its diffraction order −1 such as illustrated in FIG. 12, and the frequency f_{RF} is chosen equal to the frequency fd0.

When the frequency f_{RF} is modulated, the diffraction angle varies by Δα and the frequency of the optical wave is also modulated. This property is not used here.

It is possible for it to be impossible to obtain the desired shift frequency with a single acousto-optic modulator. According to one embodiment, the frequency shifter comprises two or more acousto-optical modulators, operating in the orders −1 or +1 depending on the desired shift frequency.

It is also possible to use a silicon-photonics acousto-optical deflector. Other types of frequency shifters may also be used.

In free space, it is possible to achieve an optical frequency shift with a number of λ/2 or λ/4 plates placed on the path of an optical wave and rotated with known angular frequencies. The frequency shift of the optical wave passing through these plates is proportional to the angular frequencies of rotation.

In integrated photonics, there are mainly two ways of achieving a frequency shift. Serrodyne modulation or SSB modulation (SSB standing for Single Side Band).

In serrodyne modulation, an electro-optical phase shifter is driven by a sawtooth signal with a peak-to-peak driving amplitude that leads exactly to a phase shift of 2π of the optical carrier. This results in a phase shift that is piecewise linear in time and therefore leads to a frequency shift that corresponds to the fundamental frequency of the sawtooth control signal. It is also possible to use thermo-optical phase shifters instead of electro-optical phase shifters.

In the case of SSB modulation, two Mach-Zehnder modulators are combined with a phase shift of π/2 to form an IQ optical modulator. The in-phase (I) and quadrature (Q) Mach-Zehnder modulators are driven with a sine signal and a cosine signal, respectively, this, in the small signal regime, leading to a frequency shift that corresponds to the frequency of the sinusoidal drive signals.

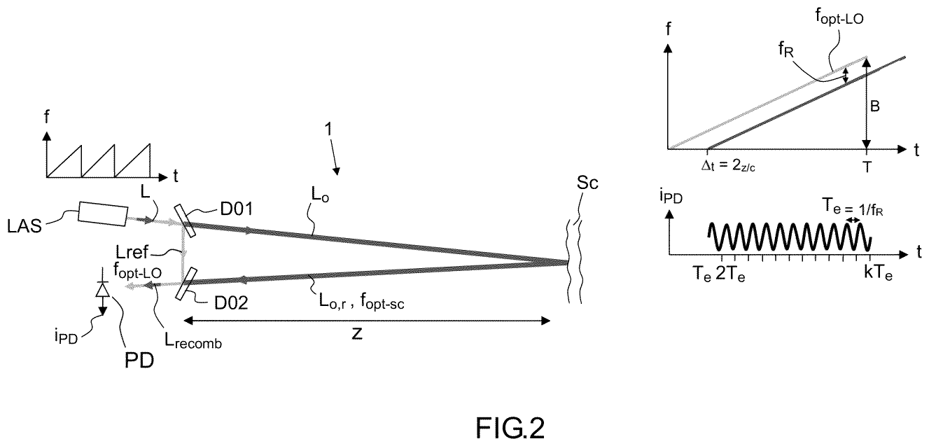

The processing carried out to determine the time at which the beat frequency fs of the detected signal Spix is minimum or zero is preferably carried out, at least in part, at the pixel level in a dedicated read circuit CL. The pixel P comprises a photodetector PD configured to generate an electrical signal Spix, typically from the heterodyne photocurrent i_{PD} (see FIG. 2), the amplitude of which depends on the intensity of the detected optical beam.

As illustrated in FIGS. 9 and 10, the dedicated read circuit CL is coupled to the photodetector PD, which delivers a signal Spix.

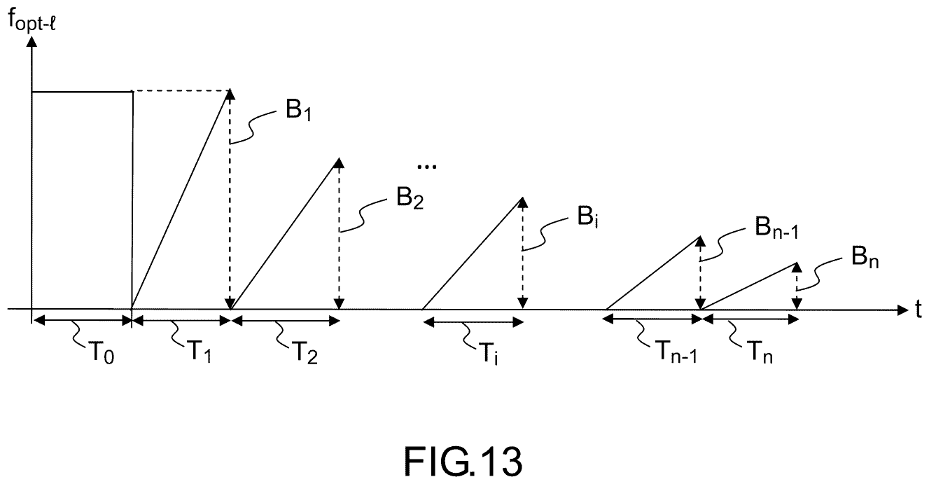

According to one embodiment of the circuit CL suitable for a matrix-array detector, a reference signal REF corresponding to the signal returned by the scene without modulation of the optical frequency is detected before the signal Spix. To this end, the optical frequency of the generated laser radiation is not modulated during a duration T0 prior to the durations Ti, such as illustrated in FIG. 13. The non-modulation of the laser beam during a duration T0, just before application of the modulations during the sub-phases Ci, is called the calibration phase. The signal detected by the photodetector during this duration T0 is called the reference signal REF.

From the equation for interference, the following are obtained:
For a modulated laser-source signal and a detected signal corresponding to a distance that is not correct, a signal I is detected such that:

$$I = {I}_{1} + {I}_{2} + 2 η \sqrt{{I}_{1} {I}_{2}} cos ( 2 π {f}_{s} t + φ )$$

with:
I1 the intensity returned by the scene,
I2 the intensity of the shifted reference/local-oscillator beam,
η the heterodyne efficiency,
fₛ the frequency of the beat signal,
φ the phase shift between the two channels.

The DC portion of this signal is thus:

$$DC = {I}_{1} + {I}_{2}$$

This assumes that integration of the AC portion will give zero, which assumes that Ti corresponds to an integer number of oscillations.
For a modulated laser-source signal and a sought distance z (formula 19), a signal is detected such that:

$$I = {I}_{1} + {I}_{2} + 2 η \sqrt{{I}_{1} {I}_{2}} cos ( φ )$$

$$( fs = 0 )$$

The DC portion of this signal is thus:

$$DC = {I}_{1} + {I}_{2} + 2 η \sqrt{{I}_{1} {I}_{2}} cos ( φ )$$

It will be noted that φ is the phase shift between the two channels, which may be anywhere between 0 and 2π, and therefore the additional DC component with respect to the previous case may be positive, negative or zero.
For an unmodulated laser-source signal, I=I₁+I₂ is detected and the DC component is DC=I₁+I₂.

In conclusion, it is therefore necessary to detect the part

I_{sig}=2η\sqrt{I₁I₂} cos(φ) superposed on the DC=I₁+I₂.

In other words, if the pixel detects a distance equal to z of expression (19), its signal is equal to the reference signal REF plus a “delta” corresponding to the additional signal I_{sig}.

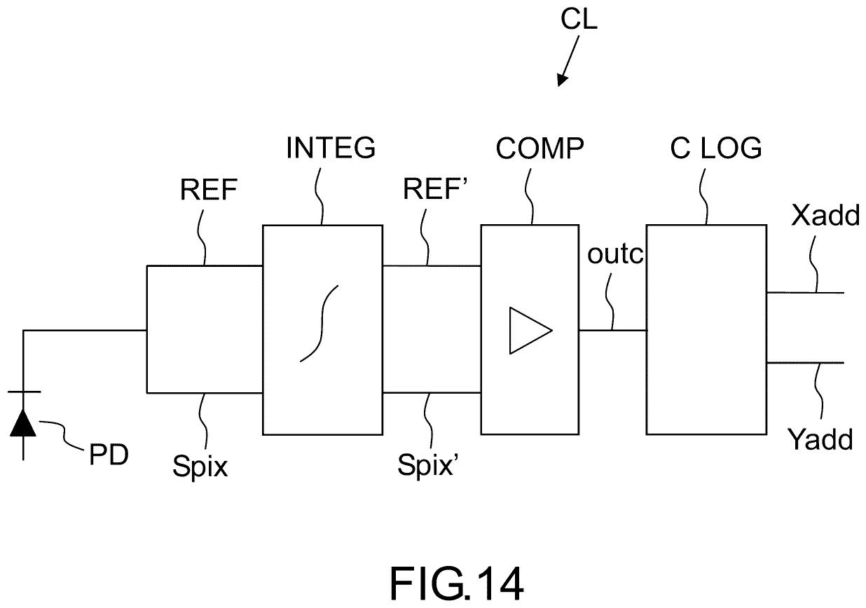

The time at which, for a pixel, the detected signal Spix is DC is thus detected using the signal REF, in the way illustrated in FIG. 14, by detecting a “delta” such as defined above.

Use is made of the fact that, since the signal to be measured is DC, a simple integration of duration equal to Ti allows the signal to be detected in each sub-period to be collected.

An integrator INTEG integrates the signals REF and SIG, which are denoted REF′ and SIG′ for each sub-period Ti (sub-phase Ci), respectively. The current sub-phase Ci during integration is identified by the circuit CL, i.e. the current values (Bi, Ti) are stored.

In each integration, if the integrated signal Spix′ is different from the integrated reference REF′, REF′ and SIG′ on being input into the comparator COMP trigger the latter and its output outc gives the order to the logic circuit CLOG to deliver the address of the pixel (Xadd, Yadd) (through dialogue with the read system). Specifically, when the modulation frequency is zero, the integrated detected signal Spix′ is different from the signal REF′, as explained above.

The value of z computed with the current values (Bi, Ti) is assigned to this pixel, and this value is stored in a memory. Once the pixel has been read, it is deactivated for the rest of the frame. In this way, in each sub-period Ti, all the pixels located at this given distance are read and deactivated. At the end of the multi-chirp signal, a depth image will have been obtained for the entire matrix array. A depth map may thus be obtained at video rate.

This architecture allows histograms of scene distance to be generated in real time. By counting the number of pixels having each distance value in a memory, the distribution of the depth values of the scene is obtained. This may be useful as it allows the multi-chirp signal to be adjusted and optimized in order to target the range of distances to be detected.

In the same way, it is possible to target a single distance or a small range in order to obtain a higher rate.

According to this embodiment, the circuit CL thus comprises an integrator INTEG that integrates REF and Spix, the result of which is the integrated signals REF′ and Spix′, a comparator COMP that switches to the high state when Spix′>REF′ and a logic circuit CLOG that delivers the address (Xadd, Yadd) of the pixel in question when the comparator is in the high state.

According to another aspect, the invention relates to a method for acquiring a distance z from a continuous-wave lidar system 10 to a scene.

In a first step, laser radiation L is generated with a laser optical frequency f_{opt-I} varying linearly over a plurality of N successive frequency ranges indexed i such as described above.

Next, the laser radiation L is spatially separated into a reference beam Lref and an object beam Lo that is directed towards a scene to be observed (Sc) and the scene is illuminated with the object beam.

At the same time, the laser optical frequency of the reference beam is shifted by a shift frequency fd0 comprised in the interval [f_{Rmax}, f_{Rmin}], with f_{Rmax} and f_{Rmin} corresponding to a beat heterodyne frequency associated with a maximum measurement distance zmax and to a minimum measurement distance zmin in the absence of the shift in the laser optical frequency of the reference beam, respectively.

Simultaneously, a recombined beam Lrecomb corresponding to a superposition of the reference beam Lref and of a beam reflected by the scene Lo,r is delivered to at least one pixel P of the detecting device Det, the recombined beam is detected and a detected signal Spix is generated.

In a processing step, first a time at which the beat frequency fs of the detected signal is zero or minimized is determined, from the detected signal. Next, the values Bi₀ and Ti₀ of the range of the laser optical frequency applied at said time are determined, and lastly information on distance z is determined from the values Bi₀ and Ti₀.

According to one embodiment, in step A, the optical frequency of the generated laser radiation is not modulated for a duration T0 prior to the durations Ti (calibration phase). In step E, a so-called reference signal REF is detected during the duration T0 and then stored. Finally, step F comprises a comparing sub-step in which, for each sub-phase, the integrated reference signal REF′ and the integrated detected signal Spix′ are compared during said sub-phase.

1. A continuous-wave lidar system comprising:
a laser source (SL) configured to generate laser radiation (L) with a laser optical frequency f_{opt-I} varying linearly over a plurality of N successive frequency ranges indexed i, with N greater than or equal to 2, a frequency range having a width Bi and a duration Ti, a sum of all said frequency ranges corresponding to an overall duration (T), an absolute value of a ratio Bi/Ti being different for each frequency range,
a first optical device (DO1) configured to spatially separate the laser radiation (L) into a reference beam (Lref) and an object beam (Lo) that is directed towards a scene to be observed (Sc),
a detecting device (Det) comprising at least one pixel (P) comprising a photodetector component (PD),
a second optical device (DO2) configured to simultaneously deliver, to said pixel, a recombined beam (Lrecomb) corresponding to a superposition of the reference beam (Lref) and of a beam reflected by the scene (Lo,r) when it is illuminated by the object beam,
a frequency shifter (FSD) placed on the path of the reference beam and configured to shift the laser optical frequency by a shift frequency (fd0) comprised in the interval [f_{Rmax}, f_{Rmin}], with f_{Rmax} and f_{Rmin} corresponding to a beat heterodyne frequency associated with a maximum measurement distance (zmax) and to a minimum measurement distance (zmin) in the absence of said frequency shifter, respectively,
a processing unit (UT) configured to drive the laser source and connected to the detecting device,
the continuous-wave lidar imaging system further being configured to determine distance information from a signal (Spix) detected by said pixel (P), the distance information being determined from the values Bi₀ and Ti₀ of the laser optical frequency range applied at the time when a beat frequency (fs) of the detected signal is zero or minimized.

2. The continuous-wave lidar system according to claim 1, wherein each frequency range indexed i corresponds to a range of distances from the sensor to the scene Δzi ranging from zₘᵢₙᵢ to zₘₐₓᵢ with zₘᵢₙᵢ<zₘₐₓᵢ, and wherein the ratios Bi/Ki are determined so that for i ranging from 1 to N−1:
$${z}_{m a {x}_{i}} = {z}_{m i {n}_{i + 1}}$$
$$where :$$
$$Ki = \frac{{z}_{m a {x}_{i}}}{{z}_{m i {n}_{i}}}$$

3. The continuous-wave lidar system according to claim 1, wherein the durations Ti are all identical.

4. The continuous-wave lidar system according to claim 1, wherein the widths Bi satisfy the relationship:
Bᵢ=K·Bᵢ₊₁ K being a real number greater than 1.

5. The continuous-wave lidar system according to claim 4, further comprising a scanner (SD) configured to illuminate the scene with the object beam point by point or line by line.

6. The continuous-wave lidar system according to claim 1, wherein the laser source and/or the first optical device are configured to illuminate the entire scene, wherein the detector comprises a plurality of pixels (Pij) arranged in a matrix array, and wherein the second optical device is configured to superpose, on the photodetector (PDij) of each pixel, the reference beam (Lref/pix) and the beam reflected by the scene (Lo,r/pix) in a substantially identical direction of propagation.

7. The continuous-wave lidar system according to claim 1, wherein the frequency shifter (FSD) comprises at least one acousto-optic modulator (AOM) operating in the order −1.

8. The continuous-wave lidar system according to claim 1, wherein a modulation in frequency range i is called sub-phase i, and wherein each pixel comprises a read circuit (CL) coupled to the photodetector (PD), the read circuit comprising:
an integrator (INTEG) that integrates, in each sub-phase, a reference signal (REF) detected by the pixel when the laser beam is not frequency modulated and the pixel signal detected during said sub-phase,
a comparator (COMP) that compares the integrated reference signal (REF′) and the integrated pixel signal (Spix′), and switches to the high state when the integrated pixel signal is different from the integrated reference signal, and
a logic circuit (CLOG) that delivers the address (Xadd, Yadd) of said pixel when the comparator is in the high state.

9. A method for acquiring a distance (z) from a continuous-wave lidar system to a scene, comprising steps of:
A generating laser radiation (L) with a laser optical frequency f_{opt-I} varying linearly over a plurality of N successive frequency ranges indexed i, a frequency range having a width Bi and a duration Ti, a sum of all said frequency ranges corresponding to an overall duration (T), an absolute value of a ratio Bi/Ti being different for each frequency range,
B spatially separating the laser radiation (L) into a reference beam (Lref) and an object beam (Lo) that is directed towards a scene to be observed (Sc),
C illuminating the scene with the object beam,
D shifting the laser optical frequency of the reference beam by a shift frequency (fd0) comprised in the interval [f_{Rmax}, f_{Rmin}], with f_{Rmax} and f_{Rmin} corresponding to a beat heterodyne frequency associated with a maximum measurement distance (zmax) and to a minimum measurement distance (zmin) in the absence of said shift in the laser optical frequency of said reference beam, respectively,
E simultaneously delivering, to at least one pixel (P) of a detecting device, a recombined beam (Lrecomb) corresponding to a superposition of the reference beam (Lref) and of a beam reflected by the scene (Lo,r), detecting said recombined beam and generating a detected signal (Spix),
F determining, from the detected signal (Spix), a time when a beat frequency (fs) of the detected signal is zero or minimized,
G determining the values Bi₀ and Ti₀ of the range of the laser optical frequency applied at said time,
H determining distance information (z) from said values Bi₀ and Ti₀.

10. The distance-acquiring method according to claim 9, wherein a modulation in frequency range i is called sub-phase i, wherein, in step A, the optical frequency of the generated laser radiation is not modulated for a duration T0 prior to the durations Ti, wherein, in step E, a signal called the reference signal is detected during the duration T0, and wherein step F comprises a comparing sub-step in which, for each sub-phase, the reference signal integrated during said sub-phase and the detected signal integrated during said sub-phase are compared.
